(19) United States
(12) Patent Application Publication
(10) Pub. No.: US 2026/0359277 A1
(43) Pub. Date: Nov. 12, 2026

(54) MAINTAINING ACTIVE AND NON-ACTIVE VECTOR DATABASE SEARCH INDEXES

(71) Applicant: International Business Machines Corporation, Armonk, NY (US)

(72) Inventors: Joseph W. Dain, Tucson, AZ (US); Paul Henri Muench, San Jose, CA (US)

(21) Appl. No.: 19/200,422

(22) Filed: May 6, 2025

(51) Int. Cl. G06F 16/22

(52) U.S. Cl. CPC G06F 16/2237

(57) ABSTRACT

A method, according to one embodiment, comprises, in response to a determination that a first search index associated with a vector database exceeds a predetermined size threshold, performing a first process for rebuilding the first search index. The first process comprises monitoring performance and accuracy of the first search index while simultaneously modifying existing content in the vector database, and maintaining the first search index and a second search index. The maintaining comprises actively using the first search index for searching the vector database while building the second search index in a non-active state based on the modification of the existing content in the vector database. The first process further comprises, in response to a determination that the performance of the first search index falls below a threshold value, actively using the second search index for searching the vector database and rebuilding the first search index in the non-active state.

### BACKGROUND

The present invention relates to data, and more specifically, this invention relates to indexes.

A vector database stores vectors which are lists of numbers that represent data, e.g., images, words, phrases, documents, files, etc. In order to search within such a database, indexing algorithms maintain and use search indexes that, when queried, return results based on relational structures of contents of the vectors. More specifically, the vectors mathematically organize and thereby represent data by placing data within different dimensions of the vectors according to features of the data. In some use cases, approximate nearest neighbor algorithms are used to query the search indexes of the vector database, where results of the query include closest matching records of the vector database.

### SUMMARY

A method, according to one embodiment, comprises, in response to a determination that a first search index associated with a vector database exceeds a predetermined size threshold, performing a first process for rebuilding the first search index. The first process comprises monitoring performance and accuracy of the first search index while simultaneously modifying existing content in the vector database, and maintaining the first search index and a second search index. The maintaining comprises actively using the first search index for searching the vector database while building the second search index in a non-active state based on the modification of the existing content in the vector database. The first process further comprises, in response to a determination that the performance of the first search index falls below a threshold value, actively using the second search index for searching the vector database and rebuilding the first search index in the non-active state.

A computer program product, according to another embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of FIG. 2A, in accordance with one embodiment of the present invention.

FIG. 2C is a flowchart of sub-operations of an operation of FIG. 2A, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for maintaining active and non-active vector database search indexes.

In one general embodiment, a method comprises, in response to a determination that a first search index associated with a vector database exceeds a predetermined size threshold, performing a first process for rebuilding the first search index. The first process comprises monitoring performance and accuracy of the first search index while simultaneously modifying existing content in the vector database, and maintaining the first search index and a second search index. The maintaining comprises actively using the first search index for searching the vector database while building the second search index in a non-active state based on the modification of the existing content in the vector database. The first process further comprises, in response to a determination that the performance of the first search index falls below a threshold value, actively using the second search index for searching the vector database and rebuilding the first search index in the non-active state.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as search index maintenance code of block 150 for maintaining active and non-active vector database search indexes. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

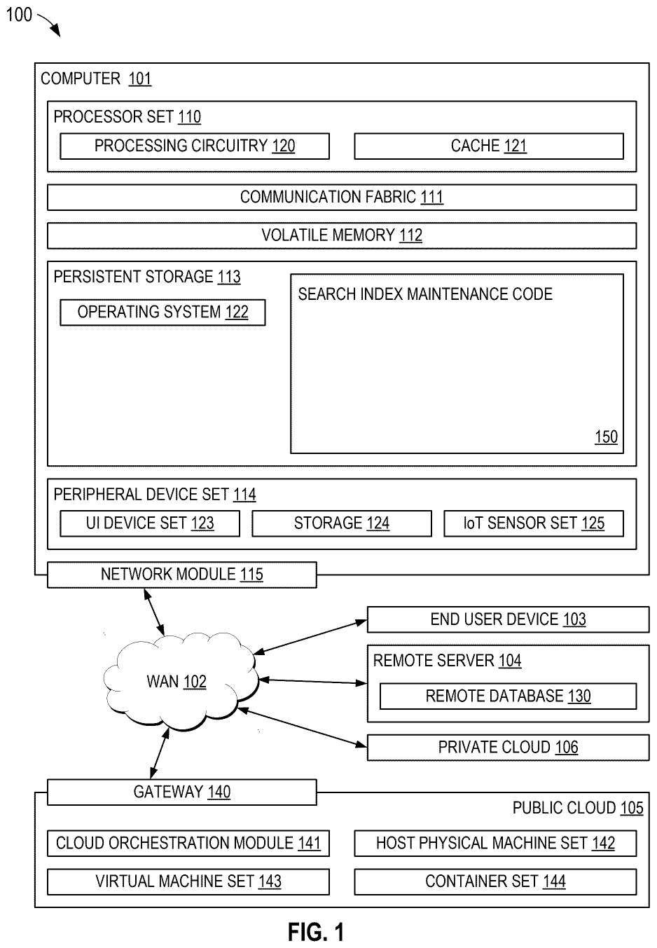

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a vector database stores vectors which are lists of numbers that represent data, e.g., images, words, phrases, documents, files, etc. In order to search within such a database, indexing algorithms maintain and use search indexes that, when queried, return results based on relational structures of contents of the vectors. More specifically, the vectors mathematically organize and thereby represent data by placing data within different dimensions of the vectors according to features of the data. In some use cases, approximate nearest neighbor algorithms are used to query the search indexes of the vector database, where results of the query include closest matching records of the vector database.

As data that the vectors represent change over time, e.g., data deleted, data added, data modified, etc., use of the search indexes return relatively less accurate results.

In Retrieval-Augmented Generation (RAG), data is stored as numerical vectors. RAG use cases for modern enterprises have a continuous churn of data that needs to be reflected in the vector datastore, however methods such the approximate nearest neighbor (ANN) search indexes can degrade based on these data changes. For example, in use cases in which a plurality of chatbots are provided as a service, the chatbots may ingest and index millions of vectors from public website content which may change relatively frequently. To ensure freshness of this content, and to ensure accuracy of a search using one or more indices, these chatbots may delete the currently ingested data and re-ingest the entire dataset periodically, e.g., once a week. This may take hours or even days to perform, which has the effect of new data not being reflected for the entire period, e.g., a week. Substantial processing overhead is incurred as a result, as additional searching operations are performed in an attempt to remedy the inaccuracy of the searches. Accordingly, there is a longstanding and unmet need for techniques that manage incremental updates of search indexes of vector databases in order to mitigate the latencies, inaccurate searches, and additional incurred searching operations described above.

In order to mitigate the issues described above, embodiments and approaches described herein offer techniques that, as data is incrementally modified in a vector database (e.g., chunks and embeddings added, deleted, modified, etc.), monitor the performance and accuracy of the currently indexed content. Relatively small indices can remain flat as performance and accuracy is excellent. Also, the accuracy of flat indices does not degrade so, in some approaches, only performance is monitored for small indices. Once performance degrades for a small index, the type of index is changed within these techniques to an index based on clustering. In response to a determination that performance and/or accuracy crosses a threshold for a larger index, a trigger is raised to rebuild the index. The index rebuild trigger can, in some approaches, be delayed if index idle time is anticipated through a time series analysis of index operations. When rebuilding the index, the current index is preferably kept active while a new passive index is generated. In response to a determination that the passive index build is completed, the passive index is made the active index. To proactively manage the rebuild for relatively larger indices to avoid any loss of accuracy, the vectors added to the database are monitored. If a vector is added to a cluster and the new vector is not an outlier for the cluster, a determination is made that there is no need to rebuild the index. However, in response to a determination that a trivial percentage of new vectors that are added to a cluster are outliers, the index is rebuilt after that index is searched a trivial number of times. Depending on the approach, trivial may be defined as zero for the most aggressive preemptive rebuild, or greater for relatively less aggressive rebuild scenarios.

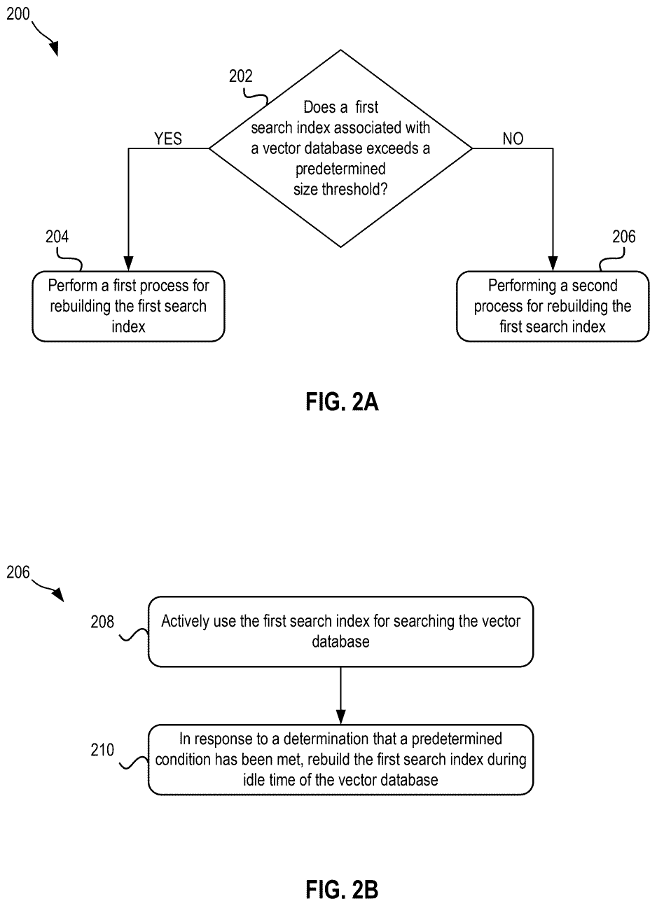

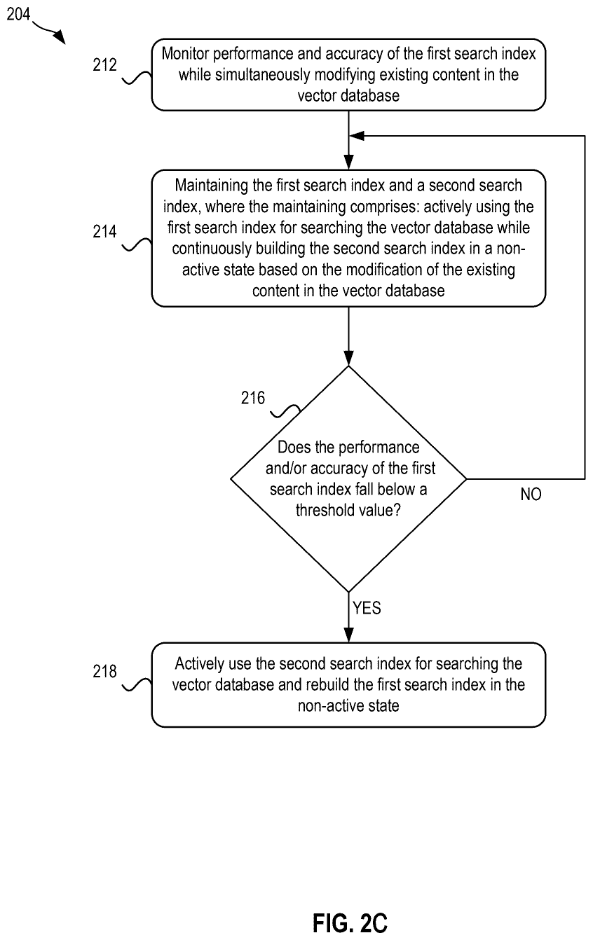

Now referring to FIG. 2, a flowchart of a method 200 is shown according to one embodiment. The method 200 may be performed in accordance with aspects of the present invention in any of the environments depicted in FIGS. 1-2, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that, in some preferred approaches, operations of method 200 may be performed in a data storage system that stores data using a vector database. This way, queries for the data may be fulfilled using one or more search indexes, which may be generated and/or maintained according to the techniques of method 200. These operations include performing a transparent threshold-based vector index rebuild based on incremental updates. More specifically, as data in the data storage system changes over time, search indexes become relatively less accurate. To increase this accuracy while minimizing latency introduced into functionality of the data storage system, the techniques described herein perform such rebuilds at determined periods of time.

Decision 202 of method 200 includes determining whether a first search index associated with (used for searching to fulfill received queries) a vector database exceeds a predetermined size threshold. In some approaches, the predetermined threshold size is a dynamically adjustable predetermined number of entries. In another approach, the predetermined threshold size is a predetermined collective storage size. For descriptions herein a search index organizes and manages vector embeddings to enable streamlined and efficient similarity searches. For example, these search indexes enable the comparison of vectors of the vector database in order to determine similar portions of data.

It should be noted that, during use of the first search index (and/or other search indexes described herein), the first search index may increase in size. This may be due to size of metadata and/or data associated with and stored with the first search index increasing, in some approaches. More specifically, the increase in size may additionally and/or alternatively be due to the number of searches that are performed using the search index and/or a size of the vector database that the first search index searches also increasing (relatively larger search results as the size of the vector database that the first search index is used to search increases). Accordingly, in some approaches, the predetermined threshold size is, in some approaches, a predetermined amount greater in size than a starting size of the first search index, e.g., the predetermined threshold size is equal to a size of the first search index upon being rebuilt and/or deployed to search the vector database plus a predetermined size.

Depending on the determined size of the first search index, in some approaches, different processes may be followed for rebuilding the first search index over time, e.g., see a second process in FIG. 2B and a first process in FIG. 2C. For example, in some approaches, in response to a determination that the first search index associated with the vector database exceeds the predetermined size threshold, e.g., as illustrated by the “YES” logical path of decision 202, a first process is performed for rebuilding the first search index, e.g., see operation 204.

Looking to FIG. 2C, exemplary sub-operations of performing the first process for rebuilding the first search index are illustrated in accordance with one embodiment, one or more of which may be used to perform operation 204 of FIG. 2A. However, it should be noted that the sub-operations of FIG. 2C are illustrated in accordance with one embodiment which is in no way intended to limit the invention.

The first process comprises monitoring performance and accuracy of the first search index while simultaneously modifying existing content (data) in the vector database, e.g., see sub-operation 212.

The performance of the first search index during the modifying is, in some approaches, based on an amount of time that queries using the first search index take to complete, e.g., an execution time of the queries in order to generate a result that includes an answer to the query. This metric may also be referred to as latency (or search time of queries performed using the first search index). In some other approaches, the performance of the first search index is additionally and/or alternatively based on relevance, which may define the precision and/or recall of the performance of the first search index. In yet another approach, the performance of the first search index is additionally and/or alternatively based on throughput. For example, performance of the first search index may additionally and/or alternatively be based on a monitoring, over time, of the number of queries that can be performed while using the first search index over a predetermined number of time, e.g., queries per second, queries per minute, queries per hour, etc. In yet another approach, performance of the first search index may additionally and/or alternatively be based on resource utilization that using the first search index takes, e.g., a percentage of CPU resources consumed, an extent of memory resources consumed, a percentage of RAM used, etc.

The accuracy of the first search index during the modifying may, in some approaches, be based on some other factors than those listed above. For example, in some approaches, the accuracy of the first search index during the modifying may be based on a precision of results obtained by use of the first search index to search the vector database. For context, a precision of the results obtained may be defined as a portion of the results that are identified as being relevant to a query performed using the first search index, e.g., identified by a result post-analysis engine of a type that would become apparent to one of ordinary skill in the art after reading the descriptions herein. In some approaches, the accuracy of the first search index during the modifying may be based on a recall of the results obtained by use of the first search index to search the vector database. The recall may be defined as the portion of the relevant results that use of the first search index obtains out of all the relevant documents in the vector database. In yet another approach, the accuracy of the first search index during the modifying may be based on an F-1 score of the results obtained by use of the first search index to search the vector database, which may be based on the precision and recall metrics mentioned above.

Because the performance and/or the accuracy of the first search index deteriorates over time based on the modifying of the existing content in the vector database, the first search index eventually needs to be rebuilt to regain performance and/or accuracies achieved during use of the vector database. In order to mitigate latency otherwise associated with rebuilding of search indexes, in some approaches, multiple search indexes are maintained at the same time. For example, sub-operation 214 includes maintaining the first search index and a second search index during the modification of the existing content in the vector database. In some preferred approaches, the maintaining comprises actively using the first search index for searching the vector database while continuously building the second search index in a non-active state based on the modification of the existing content in the vector database. Actively using the first search index for searching the vector database during performance of the first process, in some approaches, comprises using the first search index to fulfill received search queries by performing clustering based searches of the vector database. More specifically, in one or more of these approaches, the first search index may be the only actively used first search index for searching the vector database to fulfill received queries and is not rebuilt and/or added to while being actively used. In contrast, the second search index (and/or all other search indexes) remain passive, e.g., not used for fulfilling queries. Instead of being used to search the vector database while the first search index is actively used, within the passive state, the second search index is ongoingly built and/or rebuilt according to changes made within the vector database, e.g., added to. Accordingly, the second search index is not used for searching the vector database while in the non-active state (the passive state).

The first search index is, in some approaches, used until a determination is made that a predetermined monitored configurable criteria, e.g., accuracy and/or performance, of the first search index is no longer acceptable. For example, sub-operation 216 includes determining whether performance and/or accuracy of the first search index falls below a threshold value. The determination that the performance of the first search index falls below the threshold value is, in some approaches, based on a determination that a first new vector is an outlier for a first cluster of the vector database upon the first new vector being added to the first cluster. For context, a new vector being an outlier for a cluster of the vector database may indicate that the vector database has changed, based on modifications of the existing content in the vector database, to an extent that results of using the first search index begin returning clusters that deviate significantly from other results of using the first search index. Accordingly, an identification of this condition may be used for determining that performance and/or accuracy of the first search index is no longer acceptable and therefore should be rebuilt. In yet another approach, the determination that the performance of the first search index falls below the threshold value is additionally and/or alternatively based on a determination that the first search index is searched a predetermined number of times, e.g., one time, ten times, one hundred times, etc.

Use of a combination of the conditions described above for a plurality of the different performance and/or accuracy metrics described elsewhere above may ensure that the first search index is not used past a point that compromises the performance of the data storage system that stores data using the vector database.

In response to a determination that the performance of the first search index has not fallen below a predetermined threshold value, e.g., see “NO” logical path of sub-operation 216, the first search index continues to be actively used for searching the vector database while the second search index continues to be rebuilt while in the passive state (in which the second search index is not used for searching the vector database). In contrast, in response to a determination that the performance of the first search index falls below the threshold value (the active search index performance has degraded past threshold values) e.g., as illustrated by the “YES” logical path of sub-operation 216, method 200 includes actively using the second search index for searching the vector database and rebuilding the first search index in the non-active state (passive state), e.g., see sub-operation 218. Note that, in some approaches, the rebuilding of the first search index while in the non-active state include rebuilding the first search index based on the past and current (active) modifications of the existing content in the vector database. Furthermore, in some preferred approaches, the first search index is not used for searching the vector database while in the non-active passive state.

This switching of the search indexes between active and non-active states ensures that performance and accuracy of searches of the vector database remain relatively efficient and accurate despite the content in the vector database being modified. Furthermore, these techniques enable relatively greater throughput and relatively more workload computations within the data storage system over time because a search index is always being rebuilt in a non-active state and is thereby ready to replace an exhausted active search index.

Referring again to FIG. 2A, in some approaches, a determination may be made that the first search index associated with the vector database does not exceed the predetermined size threshold. It should be noted that at an initial deployment of the search index (or any other search index), the first search index may be relatively small in size. Relatively small indexes (less than a predetermined threshold size) may remain flat as performance and accuracy is excellent. During this period, in response to a determination that the first search index associated with the vector database does not exceed the predetermined size threshold, e.g., as illustrated by the “NO” logical path of decision 202, a second process for rebuilding the first search index is performed, e.g., see operation 206.

Looking to FIG. 2B, exemplary sub-operations of performing the second process for rebuilding the first search index are illustrated in accordance with one embodiment, one or more of which may be used to perform operation 206 of FIG. 2A. However, it should be noted that the sub-operations of FIG. 2B are illustrated in accordance with one embodiment which is in no way intended to limit the invention.

The second process comprises actively using the first search index for searching the vector database, e.g., see sub-operation 208. It should be noted that, in some approaches, a second search index is not maintained in a non-active state during the first search index being active in the second process because rebuild time for the first search index may be fast enough that the additional processing load that the second search index would consume would not be justified.

During use of the first search index during the second process, performance of the first search index is monitored while simultaneously modifying existing content in the vector database. It should be noted however, that, as indicated above, the accuracy of a flat index such as the first search index (while the first search index does not exceed the predetermined size threshold) does not necessarily degrade. Accordingly, in some approaches, performance of the first search index is monitored while other metrics such as accuracy of the first search index is not monitored (to thereby preserve processing resources).

In response to a determination that a predetermined condition has been met, the first search index is rebuilt during idle time of the vector database and/or idle time of the data storage system that includes the vector database, e.g., see sub-operation 210. The predetermined condition is, in some approaches, based on the performance of the first search index, where the predetermined condition is not based on the accuracy of the first search index. Instead, the performance of the first search index is based on an amount of time that queries using the first search index take to complete, in some approaches. Other performance metrics are detailed elsewhere herein and may be applied in addition to and/or as an alternative to the time metric during the performance of the second process.

The second process, in some approaches, further comprises performing one or more sub-operations for analyzing operations performed using the first search index to thereby determine when to perform the rebuild of the first search index. In preferred approaches this analysis identifies a period of time in which processing resources within the data storage system will be readily available and/or a number of queries of the vector database are relatively low (if any). Accordingly, in some approaches, the second process comprises performing a time series analysis of index operations performed during the active use of the first search index for searching the vector database. Techniques for performing a time series analysis of index operations of a type that would become apparent to one of ordinary skill in the art after reading the descriptions herein may be used. In some approaches, an artificial intelligence (AI) model trained on a training set of data that includes historical operations within the data storage system is caused, e.g., instructed, to perform the time series analysis. The idle time of the vector database is identified within results of the performed time series analysis. In some preferred approaches, the idle period is identified by estimating a rebuild time of the first search index and identifying an idle period within the time series analysis that is at least the length of time as the estimated rebuild time. The rebuilding of the first search index is scheduled during the idle time of the vector database, e.g., a rebuild operation is queued by a controller of the data storage system in response to the AI model providing the idle time to the controller.

For applications identified by analysis to be relatively demanding, e.g., relatively processing resources intensive, process more than a predetermined number of queries, offer more than a predetermined number of chatbots, etc., a preemptive rebuild of the indexes may be performed to avoid any loss in accuracy. In other words, for such applications, the rebuild of one or more indexes may occur outside of an idle time.

Over time during which the first search index is actively used for searching the vector database, the first search index may increase in size. This size may eventually exceed the predetermined size threshold, and therefore, the size of the first search index may be ongoingly compared against the predetermined size threshold during performance of the second process. The second process, in some approaches, further comprises, in response to a determination, during the scheduling, that the first search index exceeds the predetermined size threshold, rebuilding the first search index as a cluster-based search index. Here the first search index is initially a small index (less than a predetermined number of entries) before the rebuild that is not based on clustering and, based on the rebuild, becomes a cluster-based search index.

In some approaches, the operations of method 200 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to maintain and rebuild search index(es). Initial training may include reward feedback that may, in some approaches, be implemented using a subject matter expert (SME) that generally understands whether use of the AI model results in increased workload completion in a data storage system. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some approaches, deployment of this AI model includes using the AI model to not only maintain and rebuild the search index(es), but also use the search indexes to fulfil queries that are received by the data storage system.

In some further approaches, the AI model may be a large language model (LLM). In some other approaches, the AI model may be a neuromyotonic AI model that may improve performance of computer devices in an infrastructure associated with vector database searching, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from a LLM or other engine that uses results of the search index(es). Such an AI model ensures that search indexes across the entire scalable data storage system remain accurate and efficient, where the scale of such analysis and determinations would not otherwise be feasible for a human to perform. This is because humans are not able to efficiently monitor and rebuild search indexes (as the size of vector databases alone are known to be greater in scale that humans can process), and would otherwise incorporate processing delays and errors in vector database searching in the process of attempting to do so. Accordingly, management of operations described herein is not able to be achieved by human manual actions.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
in response to a determination that a first search index associated with a vector database exceeds a predetermined size threshold, performing a first process for rebuilding the first search index, the first process comprising:
monitoring performance and accuracy of the first search index while simultaneously modifying existing content in the vector database,
maintaining the first search index and a second search index, wherein the maintaining comprises: actively using the first search index for searching the vector database while building the second search index in a non-active state based on the modified existing content in the vector database, and
in response to a determination that the performance of the first search index falls below a threshold value, actively using the second search index for searching the vector database and rebuilding the first search index in the non-active state.

2. The method of claim 1, wherein the second search index is not used for searching the vector database while in the non-active state, wherein the first search index is not used for searching the vector database while in the non-active state.

3. The method of claim 1, further comprising:
in response to a determination that the first search index does not exceed the predetermined size threshold, performing a second process for rebuilding the first search index, the second process comprising:
actively using the first search index for searching the vector database, and
in response to a determination that a predetermined condition has been met, rebuilding the first search index during idle time of the vector database.

4. The method of claim 3, wherein the predetermined condition is based on the performance of the first search index, wherein the predetermined condition is not based on the accuracy of the first search index, wherein the performance of the first search index is based on an amount of time that queries using the first search index take to complete.

5. The method of claim 3, the second process further comprising:
performing a time series analysis of index operations performed during the active use of the first search index for searching the vector database,
identifying, within results of the performed time series analysis, the idle time of the vector database, and
scheduling the rebuilding the first search index during the idle time of the vector database.

6. The method of claim 5, the second process further comprising:
in response to a determination, during the scheduling, that the first search index exceeds the predetermined size threshold, rebuilding the first search index as a cluster-based search index.

7. The method of claim 1, wherein the actively using the first search index for searching the vector database during the performing the first process comprises:
using the first search index to fulfill received search queries by performing clustering based searches of the vector database.

8. The method of claim 1, wherein the determination that the performance of the first search index falls below the threshold value is based on a determination that a first new vector is an outlier for a first cluster of the vector database upon the first new vector being added to the first cluster.

9. The method of claim 8, wherein the determination that the performance of the first search index falls below the threshold value is based on a determination that the first search index is searched a predetermined number of times.

10. A computer program product comprising:
one or more computer-readable storage media; and
program instructions stored on the one or more storage media to perform operations comprising:
in response to a determination that a first search index associated with a vector database exceeds a predetermined size threshold, performing a first process for rebuilding the first search index, the first process comprising:
monitoring performance and accuracy of the first search index while simultaneously modifying existing content in the vector database,
maintaining the first search index and a second search index, wherein the maintaining comprises: actively using the first search index for searching the vector database while building the second search index in a non-active state based on the modified existing content in the vector database, and
in response to a determination that the performance of the first search index falls below a threshold value, actively using the second search index for searching the vector database and rebuilding the first search index in the non-active state.

11. The computer program product of claim 10, wherein the second search index is not used for searching the vector database while in the non-active state, wherein the first search index is not used for searching the vector database while in the non-active state.

12. The computer program product of claim 10, wherein the operations further comprise:
in response to a determination that the first search index does not exceed the predetermined size threshold, performing a second process for rebuilding the first search index, the second process comprising:
actively using the first search index for searching the vector database, and
in response to a determination that a predetermined condition has been met, rebuilding the first search index during idle time of the vector database.

13. The computer program product of claim 12, wherein the predetermined condition is based on the performance of the first search index, wherein the predetermined condition is not based on the accuracy of the first search index, wherein the performance of the first search index is based on an amount of time that queries using the first search index take to complete.

14. The computer program product of claim 12, the second process further comprising:
performing a time series analysis of index operations performed during the active use of the first search index for searching the vector database,
identifying, within results of the performed time series analysis, the idle time of the vector database, and
scheduling the rebuilding the first search index during the idle time of the vector database.

15. The computer program product of claim 14, the second process further comprising:
in response to a determination, during the scheduling, that the first search index exceeds the predetermined size threshold, rebuilding the first search index as a cluster-based search index.

16. The computer program product of claim 10, wherein the actively using the first search index for searching the vector database during the performing the first process comprises:
using the first search index to fulfill received search queries by performing clustering based searches of the vector database.

17. The computer program product of claim 10, wherein the determination that the performance of the first search index falls below the threshold value is based on a determination that a first new vector is an outlier for a first cluster of the vector database upon the first new vector being added to the first cluster.

18. The computer program product of claim 17, wherein the determination that the performance of the first search index falls below the threshold value is based on a determination that the first search index is searched a predetermined number of times.

19. A computer system comprising:
a processor set;
one or more computer-readable storage media; and
program instructions stored on the one or more storage media to cause the processor set to perform operations comprising:
in response to a determination that a first search index associated with a vector database exceeds a predetermined size threshold, performing a first process for rebuilding the first search index, the first process comprising:
monitoring performance and accuracy of the first search index while simultaneously modifying existing content in the vector database,
maintaining the first search index and a second search index, wherein the maintaining comprises: actively using the first search index for searching the vector database while building the second search index in a non-active state based on the modified existing content in the vector database, and
in response to a determination that the performance of the first search index falls below a threshold value, actively using the second search index for searching the vector database and rebuilding the first search index in the non-active state.

20. The computer system of claim 19, wherein the second search index is not used for searching the vector database while in the non-active state, wherein the first search index is not used for searching the vector database while in the non-active state.
